(19) United States
(12) Patent Application Publication
(10) Pub. No.: US 2009/0072628 A1
(43) Pub. Date: Mar. 19, 2009

(54) Antennas for Wireless Power applications

(75) Inventors: Nigel P. Cook, El Cajon, CA (US); Lukas Sieber, Olten (CH); Hanspeter Widmer, Wohlenschwill (CH)

Correspondence Address: Law Office of Scott C Harris Inc, PO Box 1389, Rancho Santa Fe, CA, 92067, US

(73) Assignee: NIGEL POWER, LLC, San Diego, CA (US)

(21) Appl. No.: 12/210,201

(22) Filed: Sep. 14, 2008

Related U.S. Application Data
(60) Provisional application No. 60/972,194, filed on Sep. 13, 2007.

(51) Int. Cl. H02J 17/00; H01Q 7/00

(52) U.S. Cl. 307/104; 307/149; 343/748; 343/866

(57) ABSTRACT

Receive and transmit antennas for wireless power. The antennas are formed to receive magnetic power and produce outputs of usable power based on the magnetic transmission. Antenna designs for mobile devices are disclosed

This application claims priority from provisional application No. 60/972,194, filed Sep. 13, 2007, the entire contents of which disclosure is herewith incorporated by reference.

### BACKGROUND

It is desirable to transfer electrical energy from a source to a destination without the use of wires to guide the electromagnetic fields. A difficulty of previous attempts has been low efficiency together with an inadequate amount of delivered power.

Our previous applications and provisional applications, including, but not limited to, U.S. patent application Ser. No. 12/018,069, filed Jan. 22, 2008, entitled “Wireless Apparatus and Methods”, the entire contents of the disclosure of which is herewith incorporated by reference, describe wireless transfer of power.

The system can use transmit and receiving antennas that are preferably resonant antennas, which are substantially resonant with a frequency of their signal, e.g., within 5%, 10% of resonance, 15% of resonance, or 20% of resonance. The antenna(s) are preferably of a small size to allow it to fit into a mobile, handheld device where the available space for the antenna may be limited. An efficient power transfer may be carried out between two antennas by storing energy in the near field of the transmitting antenna, rather than sending the energy into free space in the form of a travelling electromagnetic wave. Antennas with high quality factors can be used. Two high-Q antennas are placed such that they react similarly to a loosely coupled transformer, with one antenna inducing power into the other. The antennas preferably have Qs that are greater than 1000.

It is important to use an antenna that can be properly packaged/fit into a desired object. For example, an antenna that needs to be 24 inches in diameter would be incomparable with use in a cell phone.

### SUMMARY

The present application describes antennas for wireless power transfer. Aspects to make the antennas have higher “Q” values, e.g, higher wireless power transfer efficiency, are also disclosed.

### BRIEF DESCRIPTION OF THE DRAWINGS

These and other aspects will now be described in detail with reference to the accompanying drawings, wherein:

FIG. 1 shows a block diagram of a magnetic wave based wireless power transmission system;

FIG. 1A shows a basic block diagram of an receiver antennae intended to fit on a rectangular substrates;

FIGS. 2 and 3 show specific layouts of specific multiturn antennas;

FIGS. 4 and 5 show strip antennas formed on printed circuit boards;

FIGS. 6-8 illustrate transmit antennas;

FIG. 9 shows an adjustable tuning part;

FIG. 10 shows a tuning part formed by a movable ring;

FIG. 11 shows voltage and current distribution along an antenna loop;

FIG. 12 shows distribution of currents at flanges used to form the antenna;

FIGS. 13 and 14 show specific flanges used according to the antenna;

FIG. 15 shows a transfer efficiency for antennas; and

FIG. 16 shows a power transfer for different transmitter receiver combinations.

### DETAILED DESCRIPTION

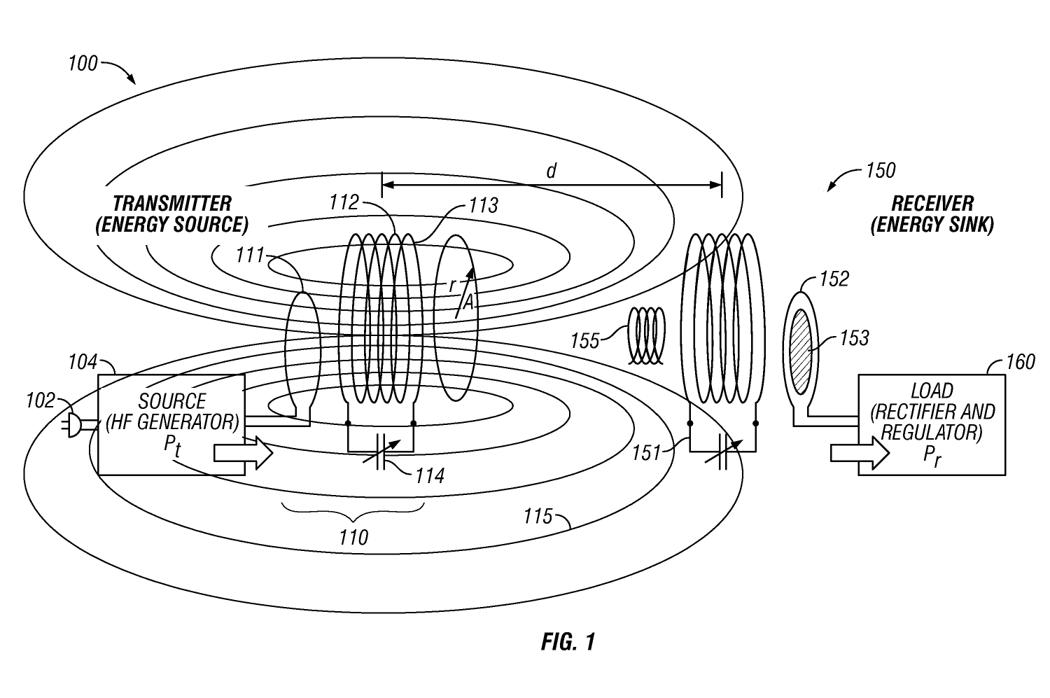

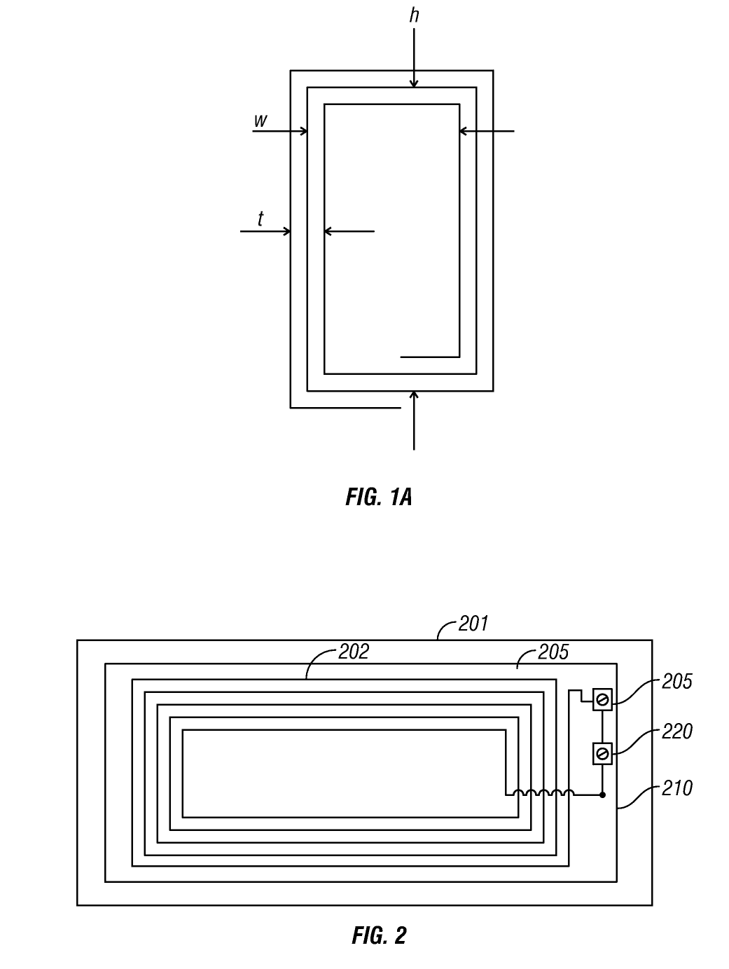

A basic embodiment is shown in FIG. 1. A power transmitter assembly 100 receives power from a source, for example, an AC plug 102. A frequency generator 104 is used to couple the energy to an antenna 110, here a resonant antenna. The antenna 110 includes an inductive loop 111, which is inductively coupled to a high Q resonant antenna part 112. The resonant antenna includes a number N of coil loops 113; each loop having a radius R_{A}. A capacitor 114, here shown as a variable capacitor, is in series with the coil 113, forming a resonant loop. In the embodiment, the capacitor is a totally separate structure from the coil, but in certain embodiments, the self capacitance of the wire forming the coil can form the capacitance 114.

The frequency generator 104 can be preferably tuned to the antenna 110, and also selected for FCC compliance.

This embodiment uses a multidirectional antenna. 115 shows the energy as output in all directions. The antenna 100 is non-radiative, in the sense that much of the output of the antenna is not electromagnetic radiating energy, but is rather a magnetic field which is more stationary. Of course, part of the output from the antenna will in fact radiate.

Another embodiment may use a radiative antenna.

A receiver 150 includes a receiving antenna 155 placed a distance D away from the transmitting antenna 110. The receiving antenna is similarly a high Q resonant coil antenna 151 having a coil part and capacitor, coupled to an inductive coupling loop 152. The output of the coupling loop 152 is rectified in a rectifier 160, and applied to a load. That load can be any type of load, for example a resistive load such as a light bulb, or an electronic device load such as an electrical appliance, a computer, a rechargeable battery, a music player or an automobile.

The energy can be transferred through either electrical field coupling or magnetic field coupling, although magnetic field coupling is predominantly described herein as an embodiment.

Electrical field coupling provides an inductively loaded electrical dipole that is an open capacitor or dielectric disk. Extraneous objects may provide a relatively strong influence on electric field coupling. Magnetic field coupling may be preferred, since extraneous objects in a magnetic field have the same magnetic properties as “empty” space.

The embodiment describes a magnetic field coupling using a capacitively loaded magnetic dipole. Such a dipole is formed of a wire loop forming at least one loop or turn of a coil, in series with a capacitor that electrically loads the antenna into a resonant state.

An embodiment describes wireless energy transfer using two LC resonant antennas operating at 13.56 MHz. Different antennas are described herein. Embodiments described different structures which the applicants believed to be optimal. According to one aspect, the transmit antennas can be larger than the receive antennas, the latter of which are intended to fit into a portable device.

FIG. 1A illustrates a first design of receiver antenna. This first design is a rectangular antenna, intended to be formed upon a substrate. FIG. 1A shows the antenna and its characteristics. The receiver can be selected according to:

$$L = \frac{{N}^{2}}{π} {μ}_{0} \cdot {μ}_{r} [ - 2 ( w \cdot h ) + 2 d - h \cdot ln ( \frac{h + d}{w} ) - w \cdot ln ( \frac{w + d}{h} ) + h \cdot ln ( \frac{2 w}{b} ) + w \cdot ln ( \frac{2 h}{b} ) ]$$

$$d = \sqrt{{w}^{2} + {h}^{2}}$$

$$C = \frac{1}{{( 2 π \cdot f )}^{2} \cdot L}$$

$${R}_{Rod} = 320 {π}^{4} \cdot ( \frac{w \cdot h}{{λ}^{2}} ) \cdot {N}^{2}$$

$${R}_{Loss} = \frac{N}{2 b} \sqrt{\frac{f \cdot {μ}_{0}}{π \cdot σ}} \cdot 2 \cdot w \cdot h \cdot ( 1 + α )$$

$$Q = \frac{1}{{R}_{Rod} + {R}_{Loss}} \cdot \sqrt{\frac{L}{c}}$$

with:
L=Inductance [H]
N=Number of turns [1]
w=mean width of the rectangular antenna [m]
h=mean height of the rectangular antenna [m]
b=wire radius [m]
C=external capacitance [F] (for resonance)
f=resonance frequency of the antenna [Hz]
λ=wavelength of resonance frequency (c/f) [m]
σ=conductivity of used material (copper=6·10⁷) [S]
[symbol] α=influence of proximity effect (0.25 for the presented antennas) [1]
Q=quality factor [1]

Assuming that T is much less than W or that T approaches zero. Depending the specific characteristics, these formulas may only produce certain approximations.

FIG. 2 shows a first embodiment of receiver antenna, referred to herein as “very small”. The very small receiver antenna might fit into for example a small mobile phone, a PDA, or some kind of media player device such as an iPod. A series of concentric loops 200 are formed on a circuit board 202. The loops form a wire spiral of approximately 40 mm×90 mm. First and second variable capacitors 205, 210 are also located within the antenna. Connector 220, e.g. a BMC connector, connects across the ends of the loop 202.

The very small antenna is a 40×90 mm antenna with 7 turns. The measured Q is around 300 at a resonance frequency of 13.56 MHz. This antenna also has a measured capacitance of about 32 pF. The substrate material of the circuit board 201 used is here FR4 (“flame retardant 4”) material which effects the overall Q. The FR-4 used in PCBs is typically UV stabilized with a tetrafunctional epoxy resin system. It is typically a difunctional epoxy resin.

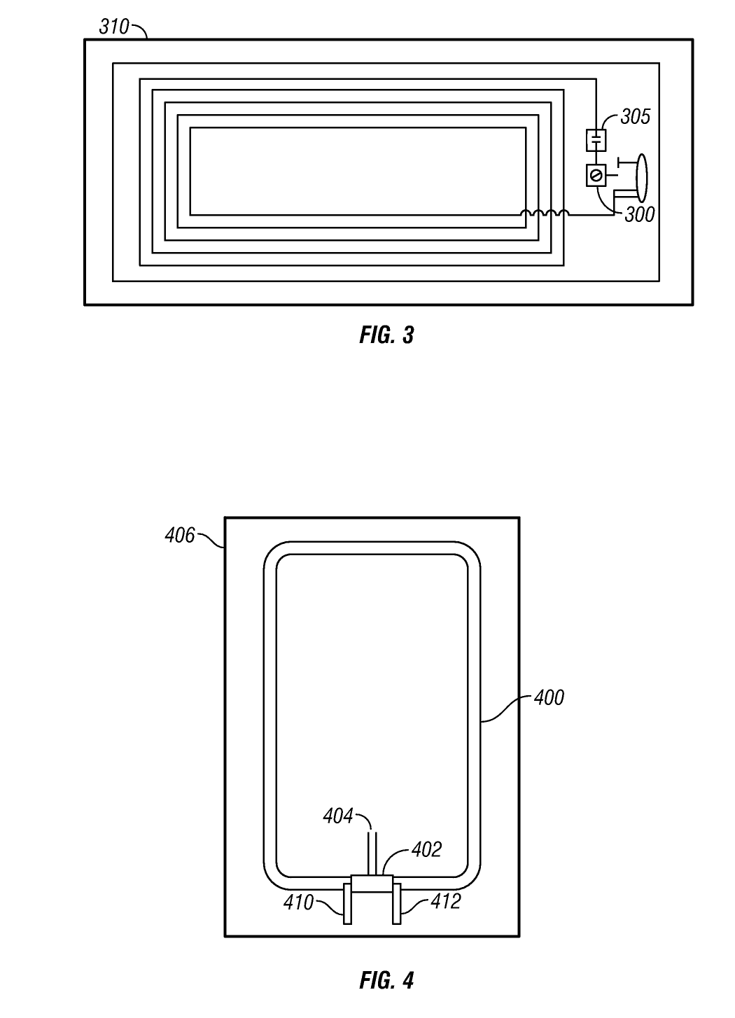

FIG. 3 shows another embodiment of a 40×90 mm antenna with six turns, a Q of 400, and a slightly higher capacitance of 35 pf. This is formed on a substrate 310 of PTFE. According to this embodiment, there is a single variable capacitor 300, and a fixed capacitor 305. The variable capacitor is variable between 5 and 16 pF, with a fixed capacitance of 33 pF. This antenna has a capacitance of 35 pF for resonance at 13.56 MHz.

One reason for the increased Q of this antenna is that the innermost turn of the spiral is removed since this is a six turn antenna rather than a seven turn antenna. Removing of the innermost spiral of the antenna effectively increases the antenna size. This increased size of the antenna increases the effective size of the antenna and hence may increase the efficiency. One thing the inventors noticed from that, therefore, is that the decrease in effective size associated with higher turn numbers may offset the larger number of turns. A fewer turn antenna can sometimes be more efficient than a larger turn antenna because the fewer can turn antenna can have a larger effective size for a specified size.

Another embodiment has a dimension of 60×100 mm, with 7 turns. The capacitance is 320 pF at a 13.56 MHz resonance frequency. A substrate material of PTFE might be used to improve the Q.

A medium-size antenna is intended for use in a larger PDA or game pad. This uses a spiral antenna of 120×200 mm.

The antenna in an embodiment may have a dimension of 60×100 mm with 7 turns, forming a Q of 320 at a resonance frequency of 13.56. A capacitance value of 22 pF can be used.

Another embodiment recognizes that a single turn structure may be optimum for an antenna. FIG. 4 shows a single turn antenna which can be used in a mobile phone on a PC board FIG. 4 illustrates a single loop design antenna. This is a single loop 400 with a capacitor 402. Both the antenna and the capacitor are formed on the PC board 406. The antenna is a strip of conductive material, 3.0 mm wide, in a rectangle of 89 mm×44 mm with rounded edges. A 1 mm gap 404 is left between the parts at the entry point. The capacitor 402 is directly soldered over that 1 mm gap 404. The electrical connection to the antenna is via wires 410, 412 which are directly placed on either side of the capacitor 402.

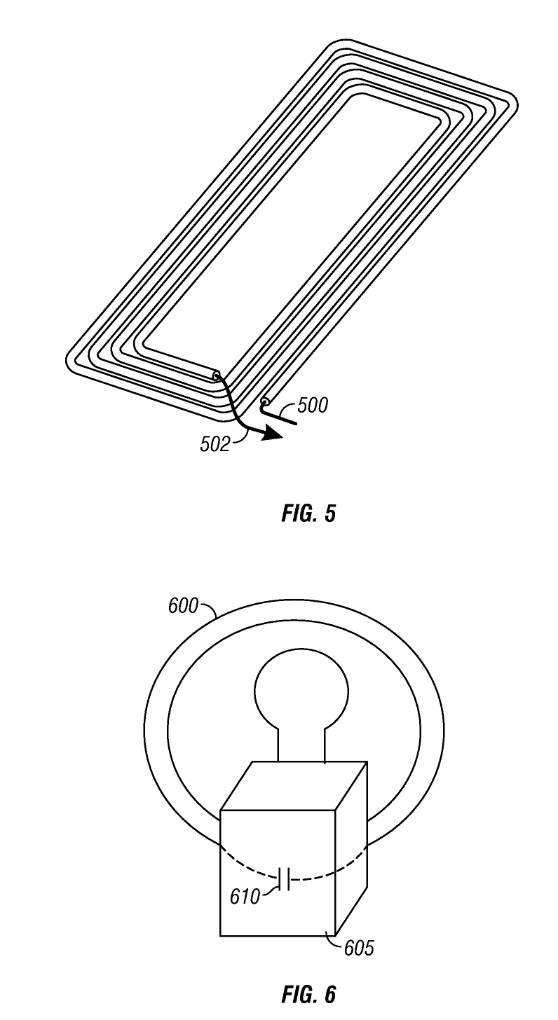

A multi-loop antenna of comparable size for a mobile phone is shown in FIG. 5. According to this figure, the signal is received between 500 and 502. This may be formed of wires or directly on a PC board. This has turns with 71 mm edge length, radius of each bend being 2 mm.

A 860 pF capacitor may be used to bring this antenna to resonance at 13.56 MHz. The capacitor may have a package with an outer surface that has first and second flat connection parts.

According to actual measurements done by the inventors, Q of the antenna was 160, which dropped to 70 when the mobile phone electronics was inside. An approximate measure was that the antenna received about 1 W of usable power at a distance of 30 cm to a large loop antenna of 30 mm copper tube acting as the transmit antenna.

The receiving antenna preferably comes within 5% of the edge of the circuit board. More specifically, for example, if the circuit board is 20 mm in width, then 5% of the 20 mm is 1 mm, and the antenna preferably comes within 1 mm of the edge. Alternatively, the antenna can come within 10% of the edge, which in the example above would be within 2 mm of the edge. This maximizes the amount of the circuit board used for the receive, and hence maximizes the Q.

The above has described a number of different receive antennas. A number of different transmit antennas were also built and tested. Each goal was to increase the quality factor “Q” of the transmit antenna and to decrease possible de-tuning of the antenna by their own structure or by external structures.

A number of different embodiments of the transmit antenna are described herein. For each of these embodiments, a goal is to increase the quality factor and decrease detuning of the antenna. One way of doing this is to keep the design of the antenna towards a lower number of turns. The most extreme design, and perhaps the preferred version, is a single turn antenna design. This can lead to very low impedance antennas with high current ratings. This minimizes the resistance, and maximizes the effective antenna size.

These low impedance antennas still have high current ratings. However, the low inductance from a single turn raises the value of the needed capacitor value for resonance. This leads to a lower inductance to capacitance ratio. This may be reduce the Q, but still may increase the sensitivity to the environment. In an antenna of this type, more of the E-filed is captured within the capacitor. The low inductance to capacitance ratio is compensated by a large surface area which provides lower copper losses.

A first embodiment of the transmit antenna is shown in FIG. 6. This antenna is called a double loop antenna. It has an outer loop 600 formed of a coil structure with a diameter as large as 15 cm. It is mounted on a base 605 that is, for example, cubical in shape. A capacitor 610 is mounted within the base. This may allow this transmitter to be packaged as a desk-mounted transmitter device. This becomes a very efficient short range transmitter.

An embodiment of the double loop antenna of FIG. 6 has a radius of 85 mm for the larger loop, a radius of approximately 20 to 30 mm for the smaller coupling loop, two turns in the main loop, and a Q of 1100 for a resonance frequency of 13.56 MHz. The antenna is brought to that resonance value by a capacitance value of 120 pF.

The 85 mm radius makes this well-suited to be a desk device. However, larger loops may create more efficient power transfer.

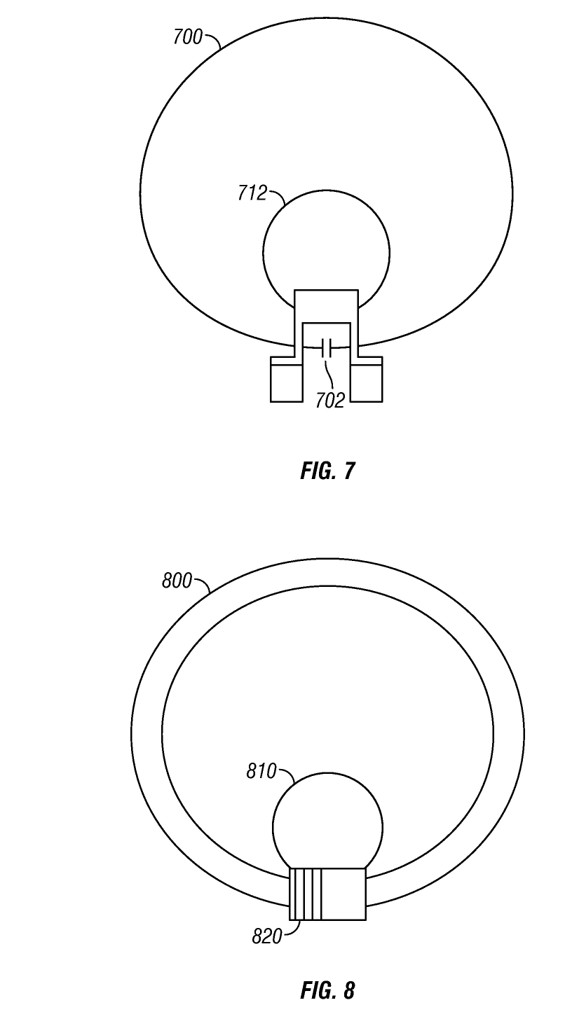

FIG. 7 illustrates the “large loop” which may increase the range of the transmitter. This is a single turn loop formed of a 6 mm copper tubing arranged into a single loop 700, with coupling structures and a capacitor coupled to the end of the loop. This loop has a relatively small surface, thereby limiting the resistance and giving good performance.

The loop is mounted on a mount 710 which holds both the main loop 700, the capacitor 702, and a coupling loop 712. This allows keeping all the structures aligned.

With a 225 mm main loop, a coupling loop of 20-30 mm diameter, this antenna can have a Q of 980 at resonance frequency of 13.56 Mhz with a 150 pF capacitor.

A more optimized large loop antenna may form a single turn antenna which combines a large area with large tube surface in order to attain high Q. FIG. 8 illustrates this embodiment.

This antenna because of its large surface area, has a high resistance of 22 milliohms. Still even in view of this reasonably high resistance, this antenna has a very high Q. Also, because this antenna has nonuniform current distribution, the inductance can only be measured by simulation.

This antenna is formed of a 200 mm radius of 30 mm copper tube 800, a coupling loop 810 of approximately 20-30 mm in diameter, showed a Q of around 2600 at resonant frequency of 13.56 Mhz. A 200 pF capacitor 820 is used. (The mount can be as shown in FIG. 14)

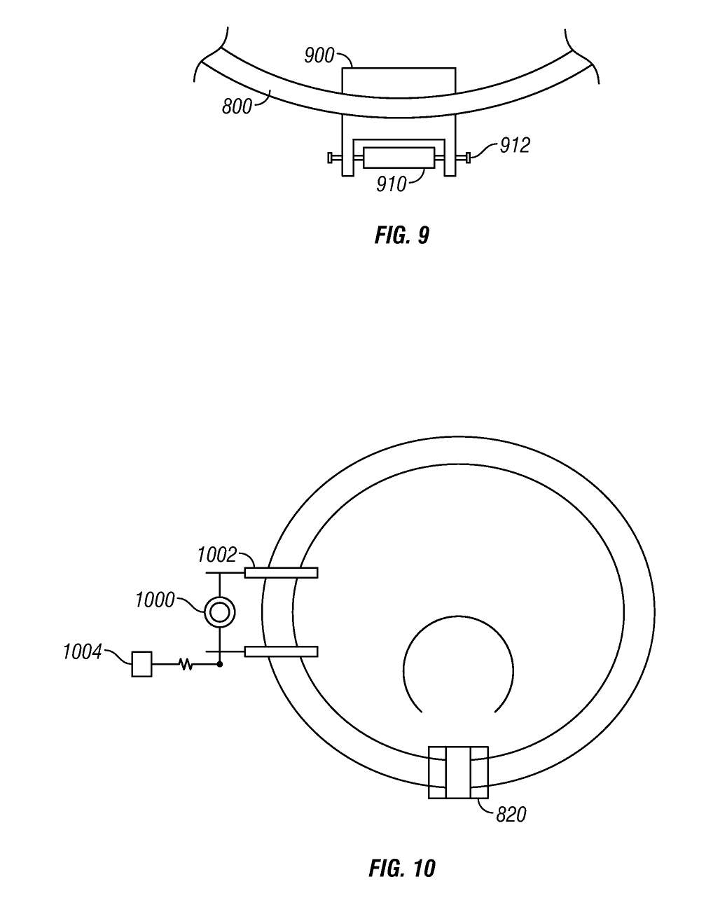

As described above, however, the inductance of this system can be variable. Accordingly, another embodiment shown in FIG. 9. This embodiment can be used with any of the previously-described antennas. The varying structure 900 can be placed near the antenna body (such as 800) may provide a variable capacitance for tuning the capacitance of the system to resonance. Plate substrates, e.g., capacitors such as 910 with a PTFE (Teflon) substrate may be used.

More generally, all instances of PTFE/Teflon described herein may use instead any material with low dielectric losses in the sense of a low tangent delta. Example materials include Porcelain or any other ceramics with low dielectric loss (tangent delta<200e-6@13.56 MHz), Teflon and any Teflon-Derivate.

This system may slide the substrate(s) 910 using an adjustment screw 912. These may slide in or out of the plate capacitors allowing changing the resonance by around 200 kHz.

These kind of capacitors impart only a very small loss to the antenna because of the desirable performance of Teflon which is estimated to have a Q greater than 2000 at 13.56 Mhz. Two capacitors can also increase the Q because small amounts of current flow through the plate capacitors, rather most of the current flows through the bulk capacitance of the antenna (e.g., here 200 pF).

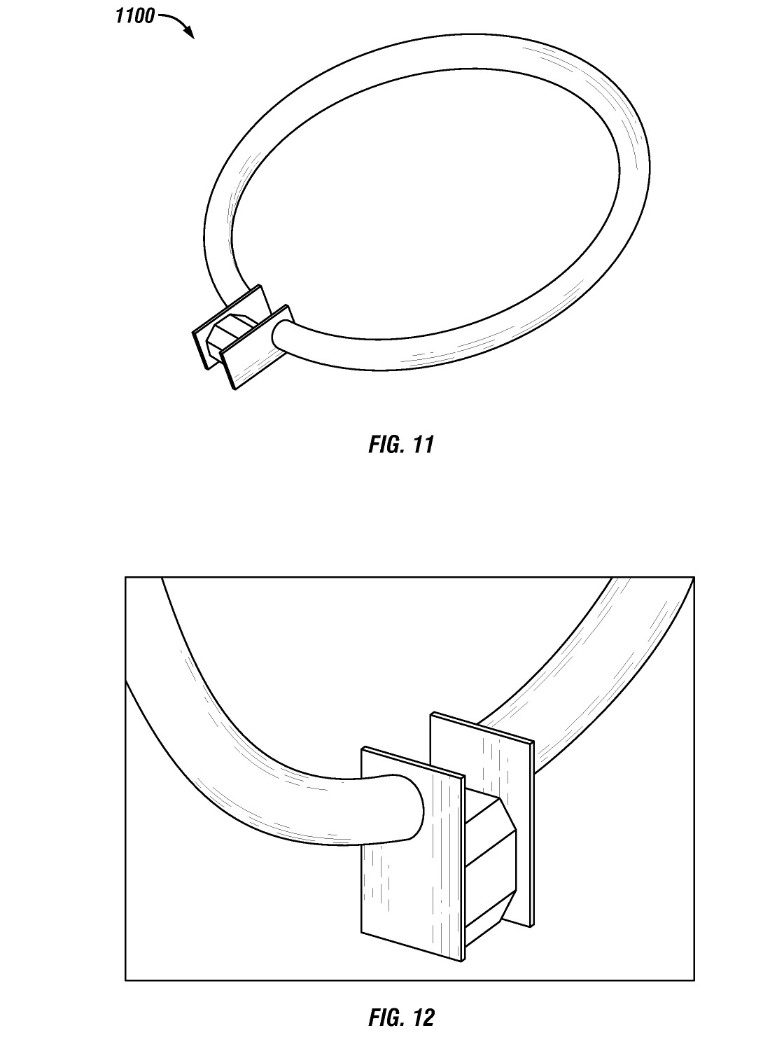

Another embodiment may use other tuning methods as shown in FIG. 10. One such embodiment uses a non-resonant metal ring 1000 as a tuning part that moves towards or away from the resonator 800/820. The ring is mounted on a mount 1002, and can adjust in and out via a screw control 1004. The ring detunes the resonance frequency of the resonator. This can change over about a 60 kHz range without noticeable Q factor degradation. While this embodiment describes a ring being used, any non-resonant structure can be used.

The resonance loop 800/820 and movable tuning loop together act like a unity coupled transformer with low but adjustable coupling factor. Following this analogy, the tuning loop is like the secondary but short-circuited. This transforms the short-circuit into the primary side of the resonator thereby reducing the overall inductance of the resonator by a small fraction depending on the coupling factor. This can increase the resonance frequency without substantially decreasing the quality factor.

FIG. 11 shows a simulation of the overall current distribution on the large transmitter antenna. The loop 1100 is shown with the concentration on the surface of the inside of the loop being higher than the current concentration on the outside of the loop. Within the inside of the antenna, the current density is highest at the top opposite the capacitor decreases towards the capacitor.

FIG. 12 illustrates that there are also two hotspots at the connection flange, a first hotspot at the welding spot, and the second hotspot at the edge of the flange. This shows that the connection between the loop and capacitor is crucial.

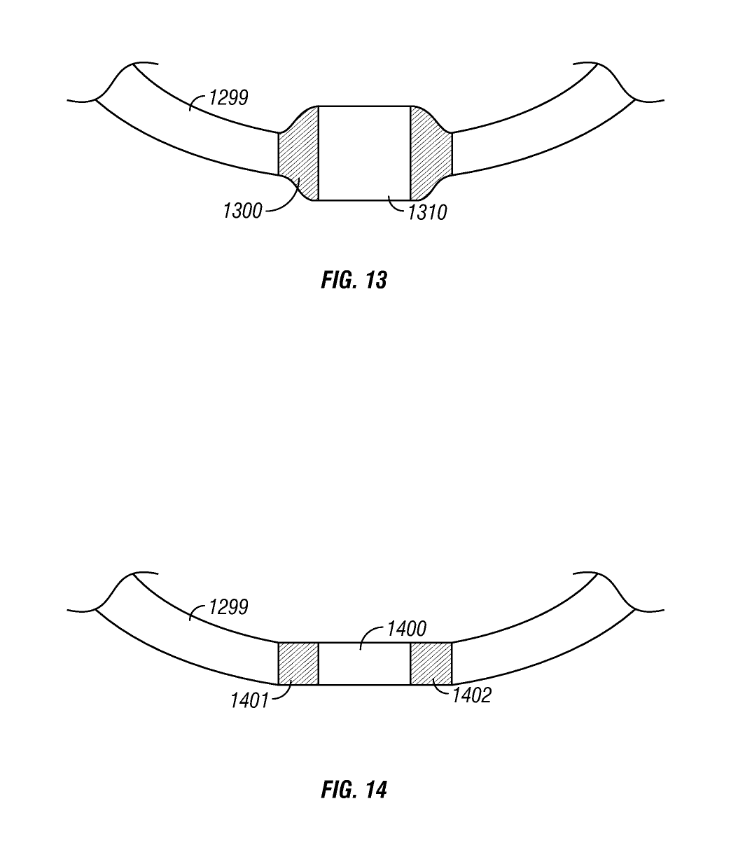

Another embodiment adapts the antennas to remove the hotspots. This was done by moving the capacitor upwards and cutting away the rectangle or ends of the flanges. This resulted in a smoother structure which is better for current flow. FIGS. 13 and 14 illustrates this. FIG. 13 illustrates a flange 1300 attached to a loop material 1299 such as copper. In FIG. 13, the capacitor 1310 is larger than the material 1200. The flange is conductive material, e.g., solder, transitioning between the loop material 1299 and the capacitor 1310. The transition can be straight (e.g., forming a trapezoid) or curved as shown.

Another way in which the antenna hotspots might be minimized for example, is by using certain kind of tuning shapes like those in FIGS. 9 and 10 near the current hotspots in order to attempt to equalize the current.

FIG. 14 shows capacitor 1400 which is the same size as the material 1299, and the transitions 1401, 1402 which are straight flanges.

A number of different materials were tested according to another embodiment. The results of these tests are shown in table 1

| | | | @ frequency | Loss | |
|---|---|---|---|---|---|
| [symbol] | Material | Q-factor | [MHz] | tangent | εᵣ |
| | FR4 1.5 mm | 45 | 14.3 | 0.0222 | 3.96 |
| | FR4 0.5 mm | 40 | 12.6 | 0.0250 | 5.05 |
| | PTFE (Teflon) 4 | >900 | 17.7 | 0.0011 | 1.18 |
| | mm | | | | |
| | PVC 4 mm | 160 | 18.5 | 0.0063 | 1.08 |
| | Rubalit | 800 | 17.7 | 0.0013 | 1.00 |

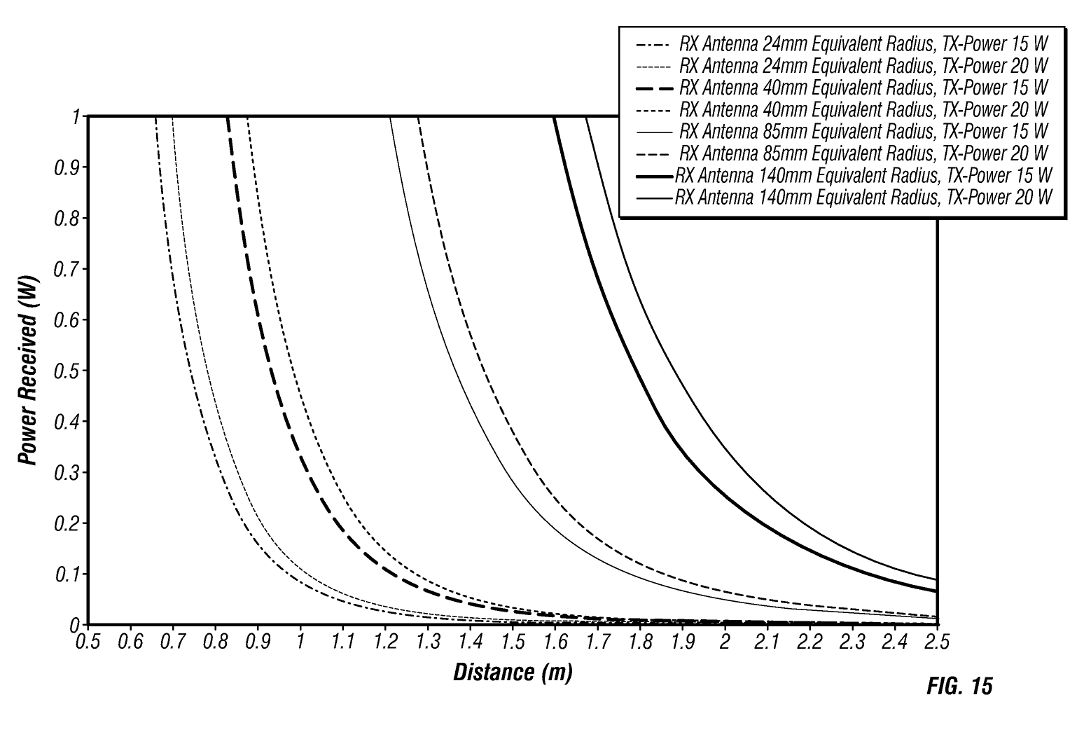

FIG. 15 illustrates the transfer efficiency for the different receiver antennas found using a testing method. This test was measuring only one point for each receive antenna that point being where the antenna receive 0.2 W. The rest of the curve is added by computation modeling a round antenna.

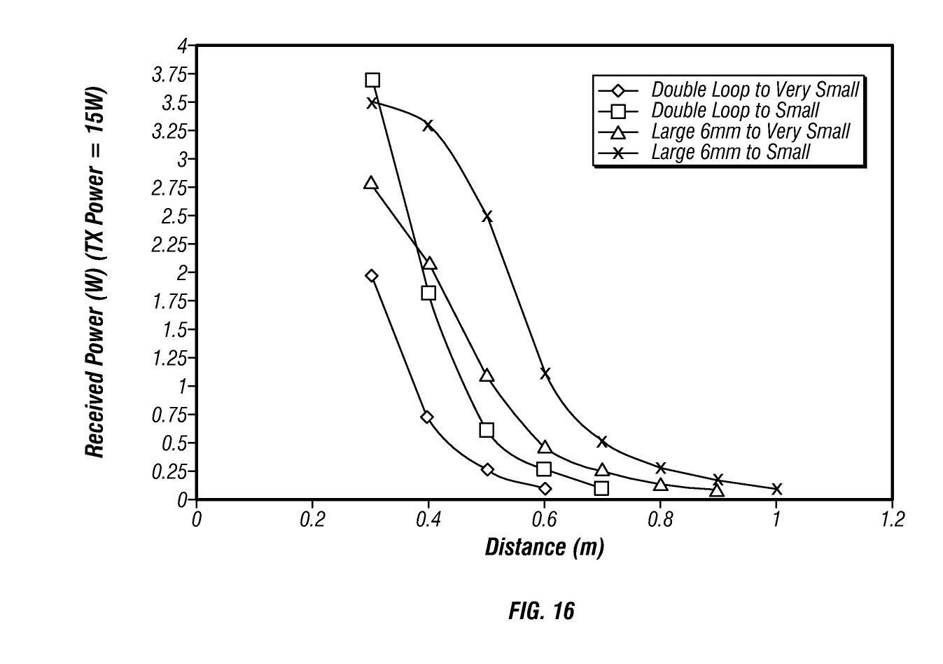

FIG. 16 illustrates system performance for a number of different antenna combinations: double loop to very small; double loop to small; large 6 mm to very small and large 6 m too small. This system chooses half what points were different receiver antennas and compares them using the same transmitting antenna. A distance increase of 15% is found when changing from the very small to small antenna. The half what points for different transmitting antennas show a distance increase of 33% when changing from the double loop antenna to the large 6 mm antenna. This increase in radius of about 159%.

To summarize the findings above, a low impedance transmitting antenna can be formed. Q may be effected due to the non-constant current distribution along the circumference of the copper tube.

Another embodiment uses a copper band instead of a copper tube. The copper band, for example, could be formed of a thin layer of copper shaped like the copper tube.

Even with a small antenna area, for receive antennas, the smallest antenna can still receive one watt at a distance of ½ m.

The materials touching and surrounding the antenna are extremely important. These materials themselves must have good Q factors. PTFE is a good material for antenna substrates.

For high-power transmitting antennas, the shape can be optimized for ideal current flow in order to reduce the losses. Electromagnetic simulation can help find areas with high current density.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above has described antennas usable at 13.56 Mhz, other frequency values can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

Any operations and/or flowcharts described herein may be carried out on a computer, or manually. If carried out on a computer, the computer may be any kind of computer, either general purpose, or some specific purpose computer such as a workstation.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A receiving antenna assembly for a mobile device, comprising:
a receiving antenna part, tuned to magnetic resonance at a specified frequency, said receiving antenna part including a circuit board, a conductive loop extending around and near an edge of said circuit board, and having an outer diameter coming to within 10% of the edge of an overall distance of the circuit board, and said receiving antenna part including a capacitive structure coupled to said circuit board, and a connection structure, coupled to said circuit board; and
at least one mobile electronic item, powered by power that is wirelessly received by said receiving antenna part and connected to said connection.

2. An antenna as in claim 1, wherein said conductive loop includes only a single loop of conductive material.

3. An antenna as in claim 1, wherein said conductive loop includes multiple loops of conductive material which are concentric to one another, and said connection is between a first portion of the loop closest to an edge of the circuit board, and a second portion of the loop closest to a center of the circuit board.

4. An antenna as in claim 1, wherein said capacitive structure includes a fixed capacitor mounted to the circuit board.

5. An antenna as in claim 1, wherein said capacitive structure also includes a variable capacitor, in parallel with the fixed capacitor and mounted to the circuit board.

6. An antenna as in claim 1, wherein said receiving part is tuned to a resonance frequency of 13.56 MHz.

7. An antenna as in claim 1, further comprising a rectifier which rectifies a signal received by said receiving, and couples power therefrom to said electronic item.

8. An antenna as in claim 7, further comprising mobile electronics in the same housing as circuit board and coupled to be powered by said he antenna.

9. An antenna assembly as in claim 1, wherein said capacitor is a variable capacitor mounted to said circuit board.

10. A wireless power transmitting assembly, comprising:
a connection that receives a signal of a specified frequency;
a first coupling loop, coupled to receive said signal;
a second, transmitting antenna, having an inductive loop portion and a capacitive portion, where the inductive portion and capacitive portion together form an LC constant that is substantially resonant with said specified frequency; and
wherein said capacitive portion is connected between distal ends of the loop portion.

11. An assembly as in claim 10, wherein said capacitive portion is in a package that has an outer surface which has first and second flat connection parts.

12. An assembly as in claim 11, further comprising a structure in said coupling loop that minimizes a current hotspot on at least one portion of the antenna.

13. An assembly as in claim 12, further comprising a flange, coupling between said coupling loop and said flat connection parts.

14. An assembly as in claim 13, wherein said flange forms a flat surface between said coupling loop and said flat connection parts.

15. An assembly as in claim 13, wherein said flange forms a curved surface between said coupling loop and said flat connection parts.

16. An assembly as in claim 12, further comprising using at least one tuning structure near the current hotspots in order to equalize the current.

17. An antenna, comprising:
a first stand portion, holding a main loop forming an antenna inductance, and also packaging a capacitor; and
said stand portion having a second portion which holds a coupling loop which is electrically disconnected from said main loop, and is smaller than main loop, and said stand having an electrical connection to said coupling loop.

18. An antenna, comprising:
a main loop portion formed of a conductive material arranged into a round loop defining an inductance;
a capacitive portion, coupled to said round loop to form an overall LC value;
a tuning portion, which is adjustable to change an inductive tuning of said main loop, by changing its inductance.

19. An antenna as in claim 18, wherein said tuning portion includes a capacitor that can be moved closer to and further from said main loop.

20. An antenna as in claim 18, wherein said tuning portion includes a non resonant portion, which can be moved closer to and farther from at least a portion of said main loop.

20. An antenna as in claim 18, wherein said tuning portion includes a part which changes an inductance of only a portion of said main loop, and can be moved closer to and farther from said main loop.

21. An antenna as in claim 20, wherein said part is located near a current hotspot on said loop.

22. An antenna as in claim 18, wherein said antenna is resonant to a magnetic frequency.

23. An antenna as in claim 22, wherein said antenna includes a power connection.

24. An antenna as in claim 1, further comprising forming the circuit board of material with low dielectric losses, and low tangent delta of less than 200×10⁻⁶.

25. An antenna in claim 24, wherein the circuit board is formed of PTFE.

26. An antenna in claim 1, wherein the circuit board is formed of a high Q material.
